(19) United States
(12) Patent Application Publication
(10) Pub. No.: US 2009/0171817 A1
(43) Pub. Date: Jul. 2, 2009

(54) REMOTE ACCOUNT MAINTENANCE SYSTEM AND METHOD

(76) Inventor: Eric Cassis, Encinitas, CA (US)

Correspondence Address: STEVEN W. WEBB, 825 College Blvd., Suite 102620, Oceanside, CA, 92057, US

(21) Appl. No.: 11/966,564

(22) Filed: Dec. 28, 2007

(51) Int. Cl. G06Q 30/00; G06Q 10/00

(52) U.S. Cl. 705/30

(57) ABSTRACT

A remote bill maintenance and payment system is described, wherein consumers and billing creditors can sign up for service. Consumer bill payment by internet access is provided, complete with accounting and status display. Creditors sign up to provide service to their customers, allowing consumer customers to send payments and receive bills remotely.

### FIELD OF THE INVENTION

This invention relates to electronic billing systems. More particularly, this invention relates to systems and methods provided for consumers to perform bill paying and bill status functions remotely via the Internet.

### BACKGROUND OF THE INVENTION

The term “consumer” is used herein to represent a typical person or business that consumes goods and services.

Creditors generate a bill or statement for each consumer account having an active account balance, or having transactions that yielded a zero balance. A creditor is any party that maintains statements for goods or services rendered to the consumer. Sample creditors are utilities, government, merchants, and intermediate billing services such as banks

Consumers typically collect the paper bills in one location which is not accessible by the consumer when the consumer is away from said location.

Often there is one designated bill payer. When a non-bill-payer handles bills, because the bill payer is away from the ordinary bill paying location, there is risk of lost bills, missed payments, and unintentional consumer default.

As part of the bill paying process, the consumer estimates cash inflow from monthly paycheck(s) or other sources, and estimates the cash outflow resulting from the bills. Once such a payment plan is finished, the consumer ordinarily pays the bills by handwritten or computer-generated check.

Conventional paper-based billing systems have many drawbacks for consumers who travel or maintain multiple addresses. Because of this, the use of personal finance management (PFM) computer software to assist consumers in managing their finances and banking over the internet has steadily increased. Examples of PFM software include “Money™” from Microsoft Corporation and “Quicken™” from Intuit, Inc. PFM software helps consumers to track their checkbooks and other financial repositories. PFM users receive paper bills, enter them into their computers, and manage payment of the bills electronically, rather than on a pad of paper. Some PFM systems are coordinated with banks such that bank account data can be downloaded in a standard PFM format, for easy inclusion in the PFM database.

A consumer-based system that handles electronic billing statements transmitted directly from the biller and enables the consumer to manage and pay his/her bills electronically remotely would be a useful tool for those who move around a lot and have to be responsible for bill paying.

Examples of state-of-the-art electronic bill payment services CheckFree Corporation, Intuit Services Corporation, and VISA Interactive. With these services, the consumer sends payment instructions to the service provider by computer or by telephone. While the PFM systems combined with bill paying services help, there is room for improvement.

### SUMMARY OF THE INVENTION

The present invention is an electronic bill payment remittance system in which electronic payments are delivered to creditors from consumers over an electronic network, such as the Internet. The software for the invention will reside entirely on an Internet Service Provider (ISP) computer connected to the internet and reachable by internet connection. The system also receives bills electronically from biller/creditors who sign up to the system.

The consumer is responsible for accumulating any printer or electronically generated bills. The bills themselves are managed on the consumer's ISP computer account, set up through the present invention. No data or very little data is maintained on the consumer's computer, permitting the portability of the bill paying system.

There are a variety of ways to notify the consumer, including displaying a bill arrival notice on the consumer's display, waking-up the computer, or launching the consumer's preferred personal finance management application. If the consumer's computer is off-line at the time, an e-mail notice can be sent.

Other features of the invention include posting creditor bills to expense ledgers based on account numbers set up by the user, saving Portable Document Format (PDF) document files to the user's storage space, and supporting multiple user account numbers per user,

Commercially available or Commercial Off-The-Shelf (COTS) software will be used for personal finance management and certain other functions of the invention. In an alternate embodiment, purpose-built software can be substituted for COTS systems where appropriate and cost-effective.

### BRIEF DESCRIPTION OF THE FIGURES

FIG. 1. Overview of the system

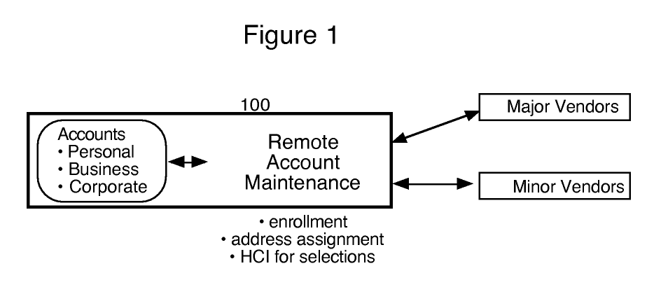

FIG. 2. Typical user actions with the system

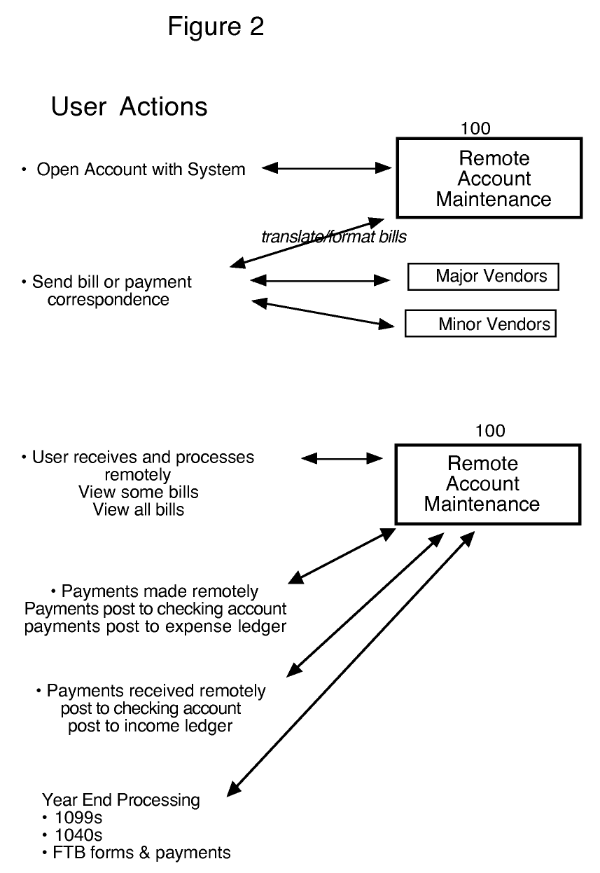

FIG. 3. Connectivity diagram for ISP software

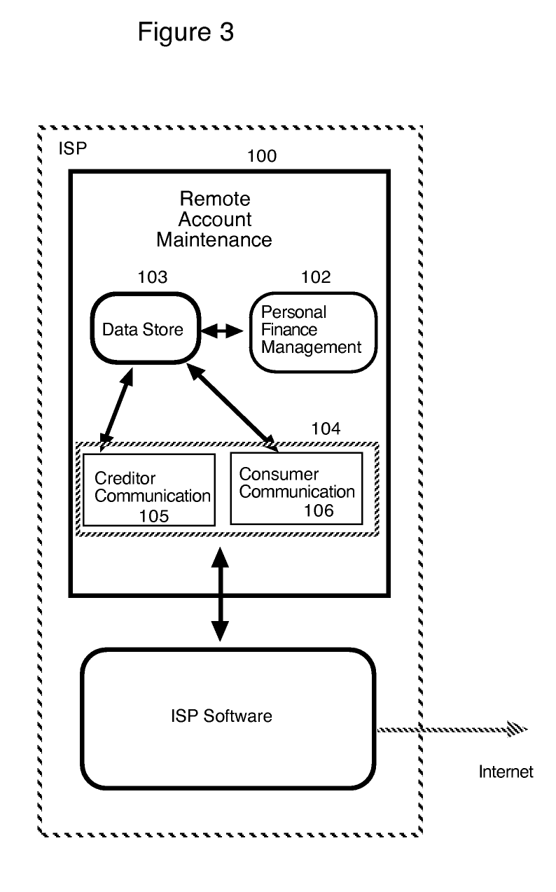

### DETAILED SPECIFICATION

The present invention 100 is comprised of several specialized software systems combine with Commercial, Off-the Shelf (COTS) software, installed on a computer-supported web site 101. The web site 101 hardware, an Internet Service Provider (ISP) computer, is selected from available ISPs, and the inventions 100 is designed to be portable across such systems.

The components of the present invention 100 include a COTS personal finance management (PFM) system 102, a data repository 103, and remote account maintenance system 104. The data repository 103 is a database serviced by a COTS database software system, such as DB2 or Oracle. The remote account maintenance system 104 interfaces with the data repository 103 on the ISP.

Within the remote account maintenance system 04 reside the customer communication function 105 and creditor communication function 106. In the preferred embodiment, customer communication 105 is implemented as a web page 107 that is programmed in a web page implementation language, such as Java or JavaScript. This web page software will manage the interaction between the consumer and the invention running on the ISP.

The creditor communication function 06 is implemented as a creditor web page 108 that is programmed in a web page implementation language and which runs on the ISP. The Universal Resource Locator (URL) for the creditor web page 108 directs the creditor who wishes to use the invention to a series of sign-up steps that capture the creditor's personal information, bank routing and account numbers, and other information. The creditor uses the creditor web page 108 to perform maintenance on its account information. The creditor web page stores the creditor information in the data repository 103.

The customer communication function 105 serves all consumers who sign up to use the invention 100. The available functions supported by the invention include signing up for remote account maintenance, agreeing to terms and conditions of use of the web site, receiving e-mail accounts associated with remote account maintenance, setting up the information to be used with the COTS PFM system 102, identifying creditor accounts and creditor account billing information, creating, sending and accounting for electronic funds transfer (EFT) transactions, and related tasks.

The method of use of the system revolves around using the invention 100 on the ISP as a remote bookkeeping and bill paying system, allowing the consumer to receive bills from creditors who have signed up for the system for the benefit of their customers, permit the consumer to schedule bill paying, account for bills paid and received by means of the COTS PFM system 102, coordinate with the customer's designated bank via bank routing numbers provided by the creditors and the customer, and generating EFT checks to creditors.

In the preferred embodiment, the invention 100 also accepts the consumer's banking transaction information from the consumer's bank in a format compatible with the COTS PFM 102 and maintains that banking information with the COTS PFM 102 tool.

While the foregoing describes a preferred embodiment of the present invention, variation on this design and equivalent designs may be resorted to in the scope and spirit of the claimed invention.

What is claimed is:

1. a remote account maintenance system for consumers and creditors, the remote account maintenance system comprised of a data store, a software system, and an internet service provider,
the software system comprised of a commercial off-the-shelf personal finance management tool, a customer communication function, and a creditor communication function,
the internet service provider a computer system connected electronically to the Internet, the internet service provider possessing ISP native software that manages and controls access to external communication means,
the data store, commercial off-the-shelf personal finance management tool, customer communication function, and creditor communication function all residing on the internet service provider,
the consumers and creditors connected electronically to the ISP,
the software system connected functionally with the data store such that each component of the software system can communicate with each of the other functions by means of data storage and recovery from the data store,
the creditor communication function and consumer communication function connected functionally to the ISP native software.

2. A remote account maintenance system as in claim 1 where the ISP native software is an e-mail system.

3. A remote account maintenance system as in claim 1 where the personal finance management tool is selected from the list of Quicken™ and Money™.

4. A method of using a remote account maintenance system as in claim 1, comprised of the steps of
using the consumer communication function, signing up for remote account maintenance,
agreeing to terms and conditions of use of the web site,
receiving account numbers associated with remote account maintenance,
setting up the information to be used with the commercial off-the-shelf personal finance management tool,
using the creditor communication function, identify creditor accounts and creditor account billing information, create, send and account for electronic funds transfer (EFT) transactions, and related tasks.

5. A method of using a remote account maintenance system as in claim 1, comprised of the steps of
using the consumer communication function, view and process a creditor transaction,
verify that the transaction was posted to automated accounting system,
review invoices and receivables by vendor and type of expense,
optionally issue paper checks at consumer computer printer.
